(19) United States
(12) Patent Application Publication
(10) Pub. No.: US 2026/0179855 A1
(43) Pub. Date: Jun. 25, 2026

(54) ALUMINUM ELECTROLYTIC CAPACITOR AND ELECTROLYTE SOLUTION THEREOF

(71) Applicant: Industrial Technology Research Institute, Hsinchu (TW)

(72) Inventors: Che Wei Pan, Hsinchu City (TW); Li-Duan Tsai, Hsinchu City (TW)

(73) Assignee: Industrial Technology Research Institute, Hsinchu (TW)

(21) Appl. No.: 19/182,660

(22) Filed: Apr. 18, 2025

(30) Foreign Application Priority Data
Dec. 25, 2024 (TW) 113150580

(51) Int. Cl. H01G 9/035; H01G 9/045; H01G 9/145

(52) U.S. Cl. CPC H01G 9/035; H01G 9/045; H01G 9/145

(57) ABSTRACT

An aluminum electrolytic capacitor and an electrolyte solution thereof are provided. The electrolyte solution of aluminum electrolytic capacitor includes an electrolyte, an organic solvent and a functional additive, wherein the functional additive includes a metal oxide having a dielectric constant ≥7. The weight percentage of the metal oxide having a dielectric constant ≥7 is up to 3 wt % based on the total weight of the electrolyte solution.

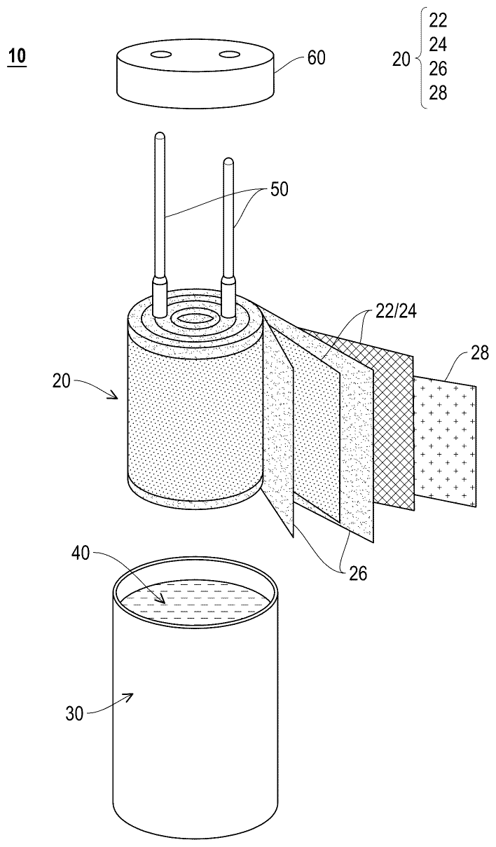

### CROSS-REFERENCE TO RELATED APPLICATION

This application claims the priority benefit of Taiwan application serial no. 113150580, filed on Dec. 25, 2024. The entirety of the foregoing patent application is hereby incorporated by reference herein and made a part of this specification.

### TECHNICAL FIELD

The disclosure relates to an aluminum electrolytic capacitor and an electrolyte solution thereof.

### BACKGROUND

Due to the large capacity, the aluminum electrolytic capacitors have been widely used in circuits for power supply smoothing and decoupling. With the vigorous development of the electronics industry, electronic equipment has increasingly higher requirements for adaptability to high and low temperature environments. Therefore, there is a need for electrolyte solution which is not prone to degradation at high temperature and may be operated at low temperature.

However, the electrolyte solutions used in the industry often increase in viscosity and deteriorate in fluidity in low temperature environments, leading to problems such as increased capacitor impedance and decreased electrolytic capacitor capacity.

Therefore, an electrolyte solution having the low temperature stability is needed.

### SUMMARY

The disclosure provides an electrolyte solution of aluminum electrolytic capacitor. The electrolyte solution of aluminum electrolytic capacitor includes: an electrolyte, an organic solvent, and a functional additive. The functional additive includes a metal oxide having a dielectric constant ≥7. A weight percentage of the metal oxide having a dielectric constant ≥7 is up to 3 wt % based on a total weight of the electrolyte solution.

The disclosure also provides an aluminum electrolytic capacitor. The aluminum electrolytic capacitor includes: a capacitor element, including: an anode foil; a cathode foil; a separator, between the anode foil and cathode foil; and the above-mentioned electrolyte solution of aluminum electrolytic capacitor, the capacitor element is impregnated in the above-mentioned electrolyte solution.

In order to make the above-mentioned features and advantages of the disclosure more clearly understandable, exemplary implementations are described below with detailed explanations together with the accompanying drawings.

### BRIEF DESCRIPTION OF THE DRAWINGS

FIGURE is a schematic disassembly view of an aluminum electrolytic capacitor according to an embodiment of the disclosure.

### DESCRIPTION OF THE EMBODIMENTS

Examples are listed below and described in detail with reference to the drawings. However, the provided examples are not intended to limit the scope of the disclosure. In addition, the drawings are for illustrative purposes only and are not drawn to original size. And for the convenience of understanding, the same elements will be described with the same symbols, and will not be described one by one in the following paragraphs.

The terms “comprise”, “include”, “have”, etc. used in this article are all open terms, which means “including but not limited to”.

As used herein, “about,” “approximately” or “substantially” includes the recited value and the average within an acceptable range of deviations from the specific value that a person of ordinary skill in the art may determine, taking into account measurements system limitations. For example, “about” may mean within one or more standard deviations of the stated value, or within ±30%, ±20%, ±10%, ±5%. Furthermore, the terms “approximately”, “approximately” or “substantially” used in this article may be used to select a more acceptable deviation range or standard deviation according to different properties, and one standard deviation does not apply to all properties.

The terms used herein are only used to illustrate the embodiments and are not intended to limit the disclosure. And unless otherwise indicated by the context, the singular form includes the plural form.

The disclosure provides an electrolyte solution of aluminum electrolytic capacitor and an aluminum electrolytic capacitor to reduce capacitor performance degradation caused by poor fluidity of the electrolyte solution at low temperatures.

First, please refer to FIGURE, which is a schematic disassembly diagram of an aluminum electrolytic capacitor according to an embodiment of the disclosure. The aluminum electrolytic capacitor 10 includes a capacitor element 20, a container 30, an electrolyte solution 40, a positive electrode/negative electrode 50 and an upper cover 60.

The capacitor element 20 includes an anode foil 22, a cathode foil 24, a separator 26 and a fixing material 28. As shown in FIGURE, the relative positions of the anode foil 22 and the cathode foil 24 are not limited, as long as they are separated by the separator 26. The positive electrode/negative electrode 50 are respectively connected to the anode foil 22 and the cathode foil 24 to form a lead-out portion, and the separator 26 may be an isolation object such as electrolytic paper, but is not limited thereto. Finally, the anode foil 22, the cathode foil 24 and the separator 26 are fixed with the fixing material 28, such as electronic tape, to form the capacitor element 20.

Then, the fixed capacitor element 20 is impregnated in the electrolyte solution 40 in the container 30, which may be, for example, an aluminum container, but is not limited thereto. The above-mentioned container 30 is then sealed with an upper cover 60 to obtain an aluminum electrolytic capacitor according to the disclosure. The upper cover 60 may be made of a plastic cover material such as rubber resin, but is not limited thereto. As shown in FIGURE, the upper cover 60 may allow the positive electrode/negative electrode 50 in the form of a guide pin to pass through and be exposed outside the upper cover 60 to facilitate the application of voltage, but is not limited to this arrangement.

In some embodiments, the electrolyte solution 40 includes an electrolyte, an organic solvent, and a functional additive, wherein the functional additive includes a metal oxide having a dielectric constant ≥7.

In some embodiments, the metal oxide having a dielectric constant ≥7 may include a valve metal oxide having a dielectric constant ≥7 or a ferroelectric material having a dielectric constant ≥7.

In some embodiments, the metal oxide having a dielectric constant 7 may be selected one or more from the group consisting of aluminum oxide, zirconium oxide, titanium dioxide, niobium oxide, barium titanate, tantalum oxide, chromium oxide, zinc oxide, titanium oxide, tungsten oxide, hafnium oxide, bismuth oxide, antimony oxide and vanadium oxide.

In some embodiments, the dielectric constant of the metal oxide included in the functional additive may be between about 7 and about 6000, such as 7-5000, 7-4000, 10-5000, 10-4000, 50-5000, 50-4000, 100-5000 or 100-4000.

The addition of metal oxides having a dielectric constant ≥7 into the electrolyte of aluminum electrolytic capacitors may overcome the characteristic deterioration caused by poor fluidity of the electrolyte solution when the aluminum electrolytic capacitor operates in low-temperature environments.

In some embodiments, the weight percentage of the metal oxide having a dielectric constant ≥7 may be up to 3 wt % based on the total weight of the electrolyte solution, such as 0.3 wt %-3 wt %, 0.3 wt %-2.5 wt %, 0.5 wt %-2.5 wt %, etc. If the amount of the metal oxide having a dielectric constant ≥7 is too low, it will not be enough to prevent the electrolyte solution 40 of the aluminum electrolytic capacitor 10 from solidifying at low temperature, causing poor fluidity. However, if the amount of the metal oxide having a dielectric constant ≥7 is too high, the electrolyte solution 40 of the aluminum electrolytic capacitor 10 may become more viscous, affecting the impregnability of the capacitor element.

In some embodiments, the electrolyte included in the electrolyte solution 40 may include ammonium azelate, ammonium adipate, ammonium sebacate, ammonium dodecanedioate, C6-C8 ammonium dicarboxylate with side chain, ammonium borate, or a combination thereof.

In some embodiments, the organic solvent included in the electrolyte solution 40 may include, for example, ethylene glycol, diethylene glycol, propylene glycol, 1,4-butanediol, glycerol, N,N-dimethylformamide, butyrolactone, diethylene glycol methyl ether, diethylene glycol monobutyl ether, valerolactone, or a combination thereof.

In order to make the above content and other objects, features, and advantages of the disclosure more obvious and understandable, preferred embodiments are listed below and described in detail with reference to the accompanying drawings.

First of all, it should be noted that the following examples and comparative examples will use electrolyte solutions 40 of different ingredients to manufacture respectively their aluminum electrolytic capacitors 10 in the following manner, just like the aluminum electrolytic capacitor 10 shown in FIGURE, the capacitor element 20 may be impregnated in the electrolyte solution 40 in the container 30. In the following examples and several comparative examples, the capacitor element 20 was stored in the container 30 with a cylindrical aluminum shell with a bottom tube shape, and was impregnated with different electrolyte solutions 40 of different ingredients. The opening of the aluminum shell container 30 was sealed by a rubber resin upper cover 60. After the charging and aging process, an aluminum electrolytic capacitor 10 (radial lead type aluminum electrolytic capacitor) having a rated voltage of 450 WV, a rated capacitance of 33 μF, and a capacitor element size of 18 mm in diameter and 20 mm in length was produced.

### The First Experimental Group: Composition of Electrolyte Solution Having Functional Additive and Low-Temperature Performance:

As shown in Table 1 below, Examples 1-4 and Comparative Examples 1-3, based on the total weight of the electrolyte solution, 6.5 wt % of 2-butylammonium suberate and 3.5 wt % of ammonium sebacate were used as electrolyte; and respectively, 0.5 wt % of aluminum oxide having a dielectric constant of 7 to 10 was added as the functional additive in Example 1, 1 wt % of zirconium oxide having a dielectric constant of 25 to 29 was added as the functional additive in Example 2, 1 wt % of titanium dioxide having the dielectric constant of 80 to 100 was added as the functional additive in Example 3, 0.5 wt % of barium titanate having a dielectric constant of 4000 to 6000 was added as the functional additive in Example 4, 1 wt % of silicon dioxide having a dielectric constant of 3.5 to 4.5 was added as the functional additive in Comparative Example 2, and 0.5 wt % of germanium dioxide having a dielectric constant of 5 to 6 was added as the functional additive in Comparative Example 3, while no functional additive was added in Comparative Example 1; ethylene glycol was added as the organic solvent of Examples 1-4 and Comparative Examples 1-3 to complete the preparation of different compositions of electrolyte solutions of Examples 1-4 and Comparative Examples 1-3.

Among them, in Examples 1-3, aluminum oxide, zirconium oxide, and titanium dioxide were added to electrolyte solutions respectively, which are valve metal oxides having a dielectric constant ≥7, and in Example 4, barium titanate was added to the electrolyte solution, which is ferroelectric material having a dielectric constant ≥7.

Then, different compositions of electrolyte solutions of Examples 1-4 and Comparative Examples 1-3 were placed in an environment of −25° C., and the states of these electrolyte solutions were observed. The results are as follows:

TABLE 1

| | | | | | | | Comparative | | |
|---|---|---|---|---|---|---|---|---|---|
| | | | Example | | | | example | | |
| First experimental group | | | 1 | 2 | 3 | 4 | 1 | 2 | 3 |
| Composition | Electrolyte | 2-butylammonium suberate | 6.5 | 6.5 | 6.5 | 6.5 | 6.5 | 6.5 | 6.5 |
| of electrolyte | | ammonium sebacate | 3.5 | 3.5 | 3.5 | 3.5 | 3.5 | 3.5 | 3.5 |
| solution | Organic | ethylene glycol | 89.5 | 89 | 89 | 89.5 | 90 | 89 | 89.5 |
| (wt %) | solvent | | | | | | | | |
| | Functional | aluminum oxide | 0.5 | | | | | | |
| | additive | (Dielectric constant 7-10) | | | | | | | |
| | | zirconium oxide | | 1 | | | | | |
| | | (Dielectric constant 25-29) | | | | | | | |
| | | titanium dioxide | | | 1 | | | | |
| | | (Dielectric constant 80-100) | | | | | | | |
| | | barium titanate | | | | 0.5 | | | |
| | | (Dielectric constant 4000- | | | | | | | |
| | | 6000) | | | | | | | |
| | | — | | | | | 0 | | |
| | | silicon dioxide | | | | | | 1 | |
| | | (Dielectric constant 3.5-4.5) | | | | | | | |
| | | germanium dioxide | | | | | | | 0.5 |
| | | (Dielectric constant 5-6) | | | | | | | |

| | | | | | | | |
|---|---|---|---|---|---|---|---|
| state of electrolyte solution at −25° C. | liquid | liquid | liquid | liquid | solid | liquid | liquid |

As shown in the results in Table 1, the electrolyte solution of Comparative Example 1 without adding functional additive have solidified in an environment of −25° C., indicating that the electrolyte solution without adding functional additive of a metal oxide having a dielectric constant greater than seven at low temperature has almost no fluidity, which may cause problems such as a rapid increase in capacitor impedance.

### The Second Experimental Group: Electrolyte Solution Having Functional Additive and Performance of Aluminum Electrolytic Capacitor

The electrolyte solutions of Examples 1-4 and Comparative Examples 1-3 of the second experimental group are the same with that of the first experimental group. According to the manufacturing method described in the first experimental group, the lead-pin aluminum electrolytic capacitors having a rated voltage of 450 WV and a rated capacitance of 33 μF were prepared, and the capacitance and impedance thereof were measured in a room temperature environment of 20° C. and in a low temperature environment of −40° C. The results are shown in Table 2. The measurement methods of the capacitance and impedance of the above-mentioned aluminum electrolytic capacitor refer to the methods described in JP2019-29598A.

Regarding the result data of low temperature characteristic (−40° C.) in Table 2, the capacitance and impedance measured in the low temperature environment of −40° C. had been converted into capacitance change rate and impedance ratio from the result data measured at room temperature and low temperature respectively. The impedance ratio is the impedance at −40° C./the impedance at 20° C., and the capacitance change rate is the capacitance at −40° C./the capacitance at 20° C. The smaller the absolute value of the capacitance change rate and impedance ratio is, the smaller the change of capacitance and impedance become between room temperature and low temperature environments. It shows that the aluminum electrolytic capacitor made of the electrolyte solution composition may still maintain its stability at low temperatures.

TABLE 2

| | | | Example | | | | Comparative example | | |
|---|---|---|---|---|---|---|---|---|---|
| Second experimental group | | | 1 | 2 | 3 | 4 | 1 | 2 | 3 |
| Electrolyte | Functional additive | | aluminum | zirconium | titanium | barium | — | silicon | germanium |
| solution | | | oxide | oxide | dioxide | titanate | | dioxide | dioxide |
| | Dielectric constant of | | 7-10 | 25-29 | 80-100 | 4000-6000 | — | 3.5-4.5 | 5-6 |
| | functional additive | | | | | | | | |
| Capacitor | Initial | Capacity | 29.91 | 30.10 | 30.49 | 30.32 | 29.96 | 30.13 | Abnormal |
| performance | characteristic | (μF) | | | | | | | appearance |
| | (20° C.) | Impedance | 44.28 | 44.70 | 43.53 | 44.38 | 44.28 | 44.04 | of capacitor |
| | | (Ω) | | | | | | | |
| | Low | Capacitance | −19.09 | −28.64 | −23.52 | −24.60 | −32.41 | −31.56 | — |
| | temperature | change | | | | | | | |
| | characteristic | rate ( % ) | | | | | | | |
| | (−40° C.) | Impedance | 2.89 | 4.62 | 4.08 | 4.26 | 5.30 | 5.36 | — |
| | | ratio | | | | | | | |

As noted in Table 2 above, the bottom of the aluminum electrolytic capacitor having the electrolyte solution of Comparative Example 3 is bulging at a room temperature of 20° C. This abnormal appearance of capacitor indicates that the composition of the electrolyte solution of the Comparative Example 3 causes gas to be generated inside the capacitor. This unstable state is prone to danger, so the capacitor measurement of the Comparative Example 3 is excluded. This phenomenon also shows that the composition of the electrolyte solution of the Comparative Example 3 is not suitable for manufacturing the aluminum electrolytic capacitor.

In addition, according to the experimental results of the capacitance change rate and impedance ratio in Table 2, the low-temperature characteristics of Examples 1-4 are better than those of Comparative Examples 1-2. In the current de facto standard of the aluminum electrolytic capacitor industry, the impedance ratio is ≤6. The impedance ratio of the aluminum electrolytic capacitor of the disclosure, which is made by using the electrolyte solution adding a metal oxide functional additive having a dielectric constant ≥7, is less than 5 at −40° C., indicating that the aluminum electrolytic capacitors made of electrolyte solution of the disclosure may still be operated stably at low temperatures.

### The Third Experimental Group: Composition of Electrolyte Solution Having Functional Additive and Capacitor Performance

Except that the content of aluminum oxide having a dielectric constant of 7-10 of the functional additive was increased from 0.5 wt % to 2.5 wt % and 5 wt % respectively, the electrolyte solutions of Example 5 and Comparative Example 4 of the third experimental group were prepared in the same manner as the method described in Example 1 of the first experimental group. Then, the lead-pin aluminum electrolytic capacitor having a rated voltage of 450 WV and a rated capacitance of 33 μF of Example 5 was prepared in the same manner as the method described in Example 1 of the second experimental group. However, the viscosity of the electrolyte solution prepared in Comparative Example 4 is too high to impregnate the capacitor element.

Except that 16 wt % of low freezing point liquids (diethylene glycol butyl ether having a freezing point of −68° C. and γ-butyrolactone having a freezing point of −43° C.) were used instead of aluminum oxide as a functional additive, the electrolyte solutions of Comparative Example 5 and Comparative Example 6 were also prepared in the same manner as the method described in Example 1 of the first experimental group. Then, the lead-pin aluminum electrolytic capacitors having a rated voltage of 450 WV and a rated capacitance of 33 μF of Comparative Example 5 and Comparative Example 6 were prepared in the same manner as the method described in Example 1 of the second experimental group.

Then, with regard to the electrolyte solutions and aluminum electrolytic capacitors prepared in the above-mentioned Example 5 and Comparative Examples 4-6, the states of the electrolyte solutions were observed in a low temperature environment of −25° C. as in the first experimental group, and the capacitances and impedances of aluminum electrolytic capacitors were measured as in the second experimental group at room temperature of 20° C. and at low temperature environment of −40° C., and the capacitance change rate and impedance ratio thereof in a low temperature environment of −40° C. were calculated. The results are shown in Table 3:

TABLE 3

| | | | | | Compar- | Compar- | Compar- |
|---|---|---|---|---|---|---|---|
| | | | Example | Example | ative | ative | ative |
| Third experimental group | | | 1 | 5 | example 4 | example 5 | example 6 |
| Composition of | Electrolyte | 2-butylammonium | 6.5 | 6.5 | 6.5 | 6.5 | 6.5 |
| electrolyte | | suberate | | | | | |
| solution (wt %) | | ammonium sebacate | 3.5 | 3.5 | 3.5 | 3.5 | 3.5 |
| | Organic | ethylene glycol (freezing | 89.5 | 87.5 | 85 | 74 | 74 |
| | solvent | point −13° C.) | | | | | |
| | Functional | aluminum oxide | 0.5 | 2.5 | 5 | | |
| | additive | (dielectric constant | | | | | |
| | | 7-10 | | | | | |
| | | diethylene glycol butyl | | | | 16 | |
| | | ether (freezing point | | | | | |
| | | −68° C.) | | | | | |
| | | γ-butyrolactone | | | | | 16 |
| | | (freezing point −43° C.) | | | | | |
| | State of electrolyte solution at −25° C. | | liquid | liquid | liquid | liquid | liquid |
| Capacitor | Initial | Capacitance(μF) | 29.91 | 29.88 | unable to | 29.83 | 29.90 |
| performance | characteristics | | | | manufacture | | |
| | (20° C.) | Impedance(Ω) | 44.28 | 44.40 | a capacitor | 44.91 | 44.23 |
| | Low | Capacitance change rate | −19.09 | −16.30 | | −35.79 | −32.45 |
| | temperature | (%) | | | | | |
| | characteristics | Impedance ratio | 2.89 | 2.68 | | 5.94 | 5.31 |
| | (−40° C.) | | | | | | |

As shown in Table 3 above, the electrolyte solutions of Example 5 and Comparative Examples 4-6 are all in a liquid state in a low temperature environment of −25° C.

According to Table 3 above, taking aluminum oxide as the functional additive for example, the aluminum electrolytic capacitor made by adding 2.5 wt % aluminum oxide to the electrolyte solution in Example 5 has similar effects to the aluminum electrolytic capacitor of Example 1. However, the viscosity of the electrolyte solution of Comparative Example 4 having 5 wt % aluminum oxide is too high to impregnate the capacitor element, resulting in the inability to manufacture a capacitor.

Furthermore, According to Table 3, the aluminum electrolytic capacitors made by adding electrolyte solutions with low freezing point liquids in Comparative Examples 5-6, the absolute values of the capacitance change rate in a low temperature environment are still higher than that in Example 1 and Example 5. Those show that the aluminum electrolytic capacitor made from the electrolyte solution having the functional additive of the disclosure are more suitable for low-temperature environments than the aluminum electrolytic capacitor made from the electrolyte solution having a low freezing point liquid.

### The Fourth Experimental Group 4: Performance of Capacitors Having Functional Additives

In the fourth experimental group, aluminum electrolytic capacitors made from the electrolyte solutions of Example 5 and Comparative Example 1 were used to measure their capacitances and dissipation factors (DF). The dissipation factor may be regarded as the degree of energy loss of the material under the action of electric field. If the value of the dissipation factor is smaller, the energy loss is smaller. Moreover, the energy loss is often shown in the form of thermal energy. Therefore, if the DF value is smaller, the thermal stability is better.

First, the capacitances and dissipation factors of the aluminum electrolytic capacitors of Example 5 and Comparative Example 1 were measured in the same manner as the industry testing standards for electrolytic capacitors: after 1,000 hours of ripple current test at 125° C., the capacitances and dissipation factors were measured respectively. The results are shown in Table 4 below:

TABLE 4

| | | | Example | Comparative |
|---|---|---|---|---|
| Fourth experimental group | | | 5 | example 1 |
| Capacitor | Initial | Capacitance | 29.83 | 30.10 |
| performance | characteristics | (μF) | | |
| | | DF (%) | 3.52 | 3.89 |
| | 1000 hours of | Capacitance | 30.17 | 30.39 |
| | ripple current | (μF) | | |
| | test at 125° C. | DF (%) | 3.82 | 5.54 |

After 1000 hours of ripple current test at 125° C., the DF value of the aluminum electrolytic capacitor without functional additive of the Comparative Example 1 rises significantly, while the DF value of the aluminum electrolytic capacitor having aluminum oxide as the functional additive of Example 5 is significantly lower than that of Comparative Example 1. It means that the thermal stability of the electrolytic capacitor having aluminum oxide as the functional additive of Example 5 is better than that of the electrolytic capacitor without functional additive of Comparative Example 1.

Based on the results of the above four experimental groups, it can be seen that the aluminum electrolytic capacitors including the electrolyte solution having a functional additive including a metal oxide of a dielectric constant ≥7 can be better and stability in low temperature environment than the aluminum electrolytic capacitor including the electrolyte solution without a metal oxide having a dielectric constant less than 7, or having a low freezing point liquid.

Based on the above, the disclosure provides an electrolyte solution for an aluminum electrolytic capacitor and an aluminum electrolytic capacitor. By adding a functional additive including a metal oxide having a dielectric constant ≥7, an aluminum electrolytic capacitor having the low temperature stability can overcome the characteristic deterioration caused by poor fluidity of the electrolyte solution.

Moreover, by using the electrolyte solution of the aluminum electrolytic capacitor of the disclosure, the aluminum electrolytic capacitor having low temperature resistance and long lifetime can meet the requirements for capacitor operating temperature, lifetime, impedance characteristics and other specifications of the electronic device.

Although the disclosure has been disclosed above through embodiments, they are not intended to limit the disclosure. Any person with ordinary knowledge in the relevant technical field may make some modifications and modifications without departing from the spirit and scope of the disclosure. Therefore, the protection scope of the disclosure shall be determined by the appended patent application scope.

What is claimed is:

1. An electrolyte solution of aluminum electrolytic capacitor, comprising:
an electrolyte;
an organic solvent; and
a functional additive, comprising a metal oxide having a dielectric constant ≥7,
wherein a weight percentage of the metal oxide having a dielectric constant ≥7 is up to 3 wt % based on a total weight of the electrolyte solution.

2. The electrolyte solution of aluminum electrolytic capacitor according to claim 1, the metal oxide is selected one or more from the group consisting of aluminum oxide, zirconium oxide, titanium dioxide, niobium oxide, barium titanate, tantalum oxide, chromium oxide, zinc oxide, tungsten oxide, hafnium oxide, bismuth oxide, antimony oxide and vanadium oxide.

3. The electrolyte solution of aluminum electrolytic capacitor according to claim 1, wherein the dielectric constant is between 7 and 6000.

4. The electrolyte solution of aluminum electrolytic capacitor according to claim 1, wherein a weight percentage of the functional additive is 0.5 wt %-2.5 wt % based on the total weight of the electrolyte solution.

5. The electrolyte solution of aluminum electrolytic capacitor according to claim 1, wherein the weight percentage of the metal oxide having a dielectric constant ≥7 is 0.3 wt %-3 wt % based on the total weight of the electrolyte solution.

6. The electrolyte solution of aluminum electrolytic capacitor according to claim 1, wherein the weight percentage of the metal oxide having a dielectric constant ≥7 is 0.5 wt %-3 wt % based on the total weight of the electrolyte solution.

7. The electrolyte solution of aluminum electrolytic capacitor according to claim 1, wherein the weight percentage of the metal oxide having a dielectric constant ≥7 is 0.5 wt %-2.5 wt % based on the total weight of the electrolyte solution.

8. The electrolyte solution of aluminum electrolytic capacitor according to claim 1, the electrolyte comprises ammonium azelate, ammonium adipate, ammonium sebacate, ammonium dodecanedioate, C6-C8 ammonium dicarboxylate with side chain, ammonium borate, or a combination thereof.

9. The electrolyte solution of aluminum electrolytic capacitor according to claim 1, the organic solvent comprises ethylene glycol, diethylene glycol, propylene glycol, 1,4-butanediol, glycerin, N,N-dimethylformamide, γ-butyrolactone, caprolactone, glycol methyl ether, diethylene glycol monobutyl ether, valerolactone, or a combination thereof.

10. An aluminum electrolytic capacitor, comprising:
a capacitor element, comprising:
an anode foil;
a cathode foil; and
a separator, interposed between the anode foil and the cathode foil; and
an electrolyte solution of aluminum electrolytic capacitor of claim 1, wherein the capacitor element is impregnated with the electrolyte solution.
